(19) United States
(12) Patent Application Publication
(10) Pub. No.: US 2005/0047366 A1
(43) Pub. Date: Mar. 3, 2005

(54) Random access communication opportunity method

(75) Inventors: Amitava Ghosh, Buffalo Grove, IL (US); Robert T. Love, Barrington, IL (US); Nick W. Whinnett, Marlborough (GB)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/919,920

(22) Filed: Aug. 17, 2004

Related U.S. Application Data
(60) Provisional application No. 60/497,654, filed on Aug. 25, 2003.

(51) Int. Cl. H04Q 7/00; H04J 3/16; H04B 7/212

(52) U.S. Cl. 370/329; 370/437; 370/443

(57) ABSTRACT

During a random access communication opportunity (12), user equipment (20) utilizes either or both of an adaptive modulation and coding-based communication protocol (26) and an HARQ-based communication protocol (27) to achieve improved performance. This can avoid the need to establish dedicated channels (13) to support the required communications. In one embodiment, a plurality of adaptive modulation and coding-based communication protocols are provided with a given protocol being selected as a function of one or more governing criteria. For example, the protocol can be selected as a function of a quality condition of the communication path, as a function of a memory buffer, and so forth.

### RELATED APPLICATIONS

We claim the benefit of Provisional Patent Application No. 60/497,654, filed on Aug. 25, 2003.

### TECHNICAL FIELD

This invention relates generally to communications and more particularly to use of a random access communication opportunity.

### BACKGROUND

Various communications protocols are known in the art. For example, the Third Generation Partnership Project (3GPP) has been working towards developing a number of protocols for use with a wireless communication path. The original scope of 3GPP was to produce globally applicable technical specifications and technical reports for a 3rd generation mobile system based on evolved Global System for Mobile communication (GSM) core networks and the radio access technologies that they support (i.e., Universal Terrestrial Radio Access (UTRA) including both Frequency division duplex and time division duplex modes). 3GPP's scope was subsequently amended to include the maintenance and development of GSM technical specifications and technical reports including evolved radio access technologies (e.g. General Packet Radio Service (GPRS) and Enhanced Data rates for GSM Evolution (EDGE)).

Section 6 of 3GPP's Specification 25.214 (which Specification is incorporated herein by this reference) describes, in part, a random access channel (RACH) protocol and in particular a physical random access procedure. This 3GPP UMTS specification permits an overall procedure that allows for various protocol/operational states to suit varying degrees of needed, anticipated, and/or desired operational activity for transmission of data packets. Unfortunately, while one of these states designed to support relatively high transmission data activity serves that purpose fairly well, another of these states designed to support lower levels of data transmission activity in fact appears to have been too modestly specified, at least for some desired applications. Both peak rates and overall user throughput for this latter state are potentially inadequate to adequately serve many likely operational needs. Furthermore, uplink latency performance also appears to inappropriately lengthy under at least some operating circumstances during this state.

### BRIEF DESCRIPTION OF THE DRAWINGS

The above needs are at least partially met through provision of the random access communication opportunity method described in the following detailed description, particularly when studied in conjunction with the drawings, wherein:

FIG. 1 comprises a prior art state diagram as configured in accordance with 3GPP UMTS Rel-99, Rel-4 and Rel-5 standards;

FIG. 2 comprises a block diagram as configured in accordance with an embodiment of the invention;

FIG. 3 comprises a schematic depiction of various random access channel message size options as configured in accordance with an embodiment of the invention;

FIG. 4 comprises a flow diagram as configured in accordance with an embodiment of the invention;

FIG. 5 comprises a flow diagram as configured in accordance with another embodiment of the invention; and

FIG. 6 comprises a flow diagram as configured in accordance with yet another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a plurality of enhanced uplink dedicated channels can be provided (during, for example, a corresponding communication path state) for specified users from time to time to facilitate relatively medium to high data transmission rate communications for such users. At other times, uplink data transmission using random access channel (RACH) communication opportunities can be provided (during, for example, a different corresponding communication path state). Pursuant to these embodiments, such random access communication opportunities are preferably characterized by either or both of a hybrid automatic repeat request (HARQ) based communication protocol or an adaptive modulation and coding-based communication protocol. In a preferred approach, a plurality of selectable message frame sizes are also available for selective use and application.

Pursuant to one embodiment, a plurality of candidate adaptive modulation and coding-based communication protocols are available. User equipment (or a base site) can select a particular protocol based upon various appropriate criteria. For example, a particular protocol can be selected as a function, at least in part, of a sensed or otherwise ascertained quality condition of the communication path and/or of a condition of a memory buffer for the user equipment.

So configured, the random access communication opportunities are better leveraged to achieve reduced latency and improved data throughput (including both improved peak data throughput and overall data throughput). Furthermore, such improvements can be gained in a manner that is fully or substantially compatible with existing standards such as 3GPP Technical Specification 25.211 to 25.214. These benefits in turn can lead to a more efficient usage of the overall communication path itself as need for the higher transmission capable operational state (or states) can be reduced by meeting many communication needs with the improved performance of the lower transmission activity state (or states).

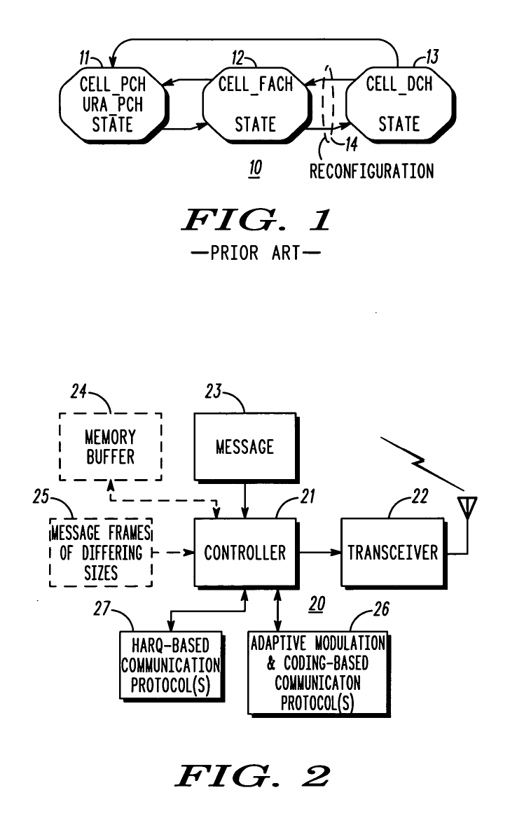

Referring now to FIG. 1, additional detail regarding the 3GPP technical Specification 25.331 may be helpful to better understand these embodiments. In essence, this Specification provides three primary states 10. A first state 11 comprises a so-called CELL_PCH/URA_PCH state and essentially serves during periods devoid of transmission activity. A second state 12 comprises a so-called CELL-FACH state and serves both to aid in establishing dedicated channels as per a third state 13 and to itself support low levels of transmission activity. This CELL_FACH state uses a random access procedure (comprising a modified slotted ALOHA protocol) in the uplink by sending a preamble at increasing power level until detected by the network and acknowledged with an acquisition indicator that is transmitted on an acquisition indicator channel. In case of a positive acknowledgement via the acquisition indicator a message frame of length 10 ms or 20 ms is transmitted after a few slots of the last acknowledged preamble. The third state 13 (the so-called CELL-DCH state) supports higher levels of transmission activity by use of dedicated channels. The latter are established and/or are maintained through a reconfiguration exchange 14 that can include the CELL_FACH state 12.

These embodiments are generally directed towards modified usage and configuration of the CELL_FACH state 12 to permit improved leveraging of the random access communication opportunities afforded thereby (and in particular the message portion of such a random access procedure). It will be understood by those skilled in the art, however, that such embodiments are illustrative in nature and are not exhaustive of all potential applications of these teachings. Such alternative applications and their corresponding embodiments are to be considered as being within the scope of these teachings and of this invention.

With reference now to FIG. 2, user equipment 20 suitable for use herein will preferably include a controller 21 that operably couples to a transceiver 22 to permit the transmission of, for example, bearer content such as a message 23. In a preferred embodiment the transceiver 22 comprises a wireless transceiver that is otherwise compatible with 3GPP Specification 25.211 to 25.21. Other transceivers can of course be utilized as appropriate to ensure compatible operation within a communication system of choice. Such user equipment 20 can also optionally include a memory buffer 24 as is otherwise well understood in the art. Such a memory buffer 24 can be utilized, for example, to support the useful transmission and/or reception of bearer content. User equipment is generally well understood in the art and those skilled in the art will recognize that other components and/or capabilities will be also provided to suit the needs of a given application. Elaboration regarding the above-described components and description of such additional components will therefore not be related here for the sake of brevity and the preservation of focus.

In a preferred embodiment, the user equipment 20 will also include at least one of a mechanism 25 for selecting a message frame size from a set of different message frame sizes, an adaptive modulation and coding-based communication(s) 26, and an HARQ-based communication protocol(s). While such components and/or functionality are also generally understood in the art, additional details are presented below as appropriate to permit a more complete understanding of these embodiments.

In this embodiment, the random access communication opportunity comprises a radio access channel mechanism comprised of two 10 millisecond frames that are each comprised of 15 access slots that each comprise 5,120 chips.

As noted above, in one embodiment, the controller 21 has access to a plurality of message frames of differing sizes 25. In the 3GPP Specification 25.211 to 25.214, two such differently sized message frames are offered; one having a 10 millisecond duration and another having a 20 millisecond duration. A preferred embodiment offers at least one more option regarding frame size. In particular, such an embodiment additionally provides a smaller frame size having a 3.33 millisecond duration. Such a 3.33 millisecond message frame can be realized through use of five 0.6667 ms time slots.

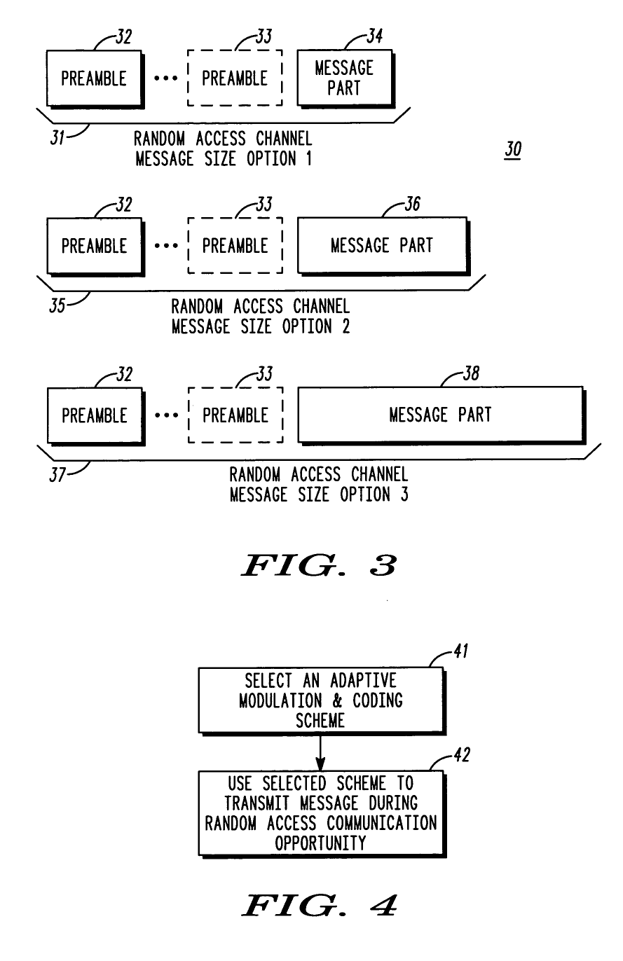

With reference to FIG. 3, so configured, three random access channel message size options 30 are thereby rendered available to such a controller 21. Each random access channel includes at least one preamble portion 32 (and potentially more preamble portions 33) comprising, in this embodiment, 4,096 chips per preamble to support uplink random access procedure and actions in accordance with Specification 25.211 to 25.214. A first random access channel message size option 31 provides the message part 34 having the shortest duration. A second random access channel message size option 35 provides a message part option having a medium length duration. And a third random access channel message size option 37 provides a message part option having a longest length duration.

So configured, the controller 21 can select a given random access channel message size option to better suit the potential requirements of a given intended transmission. The shorter duration message frame 34 can be usefully employed to reduce uplink latency and/or to better facilitate an HARQ-based exchange as described below, at least under some operating conditions. One potential advantage of the shorter RACH message option is that as the message frame length increases the channel conditions will increasingly change relative to when the preamble was sent due to the fading correlation of the channel. Hence, with shorter messages the channel will have changed less by the end of the message frame. The preamble ramping employed in the RACH procedure can be considered to be a crude form of power control, and therefore the shorter RACH message length means that the RACH message will be better power controlled.

Referring again to FIG. 2, the controller 21 also has access, in a preferred embodiment, to one or more adaptive modulation and coding-based communication protocols 26. For example, pursuant to one embodiment, the user equipment 20 supports three such protocols. Example protocols for potential use include but are not limited to:
a first selectable protocol comprising binary phase shift keying and various channel coding rates;
a second selectable protocol comprising quadrature phase shift keying and various channel coding rates; and
a third selectable protocol comprising 8 phase shift keying and various channel coding rates.

Such a selection permits a useful range of data throughput opportunities. For example , presuming a maximum channel bit rate of 480 kbps (that is, the payload for a 3.33 millisecond message frame can be 960 bits with R=0.615 coding assuming 16 cyclic redundancy check (CRC) bits and 8 tail bits), various exemplary available random access channel message fields for binary phase shift keying and quadrature phase shift keying are shown in Table 1. Also, the random access message control fields are shown in Table 2. The control field bits carries the pilot and transport format combination indicator (TFCI) field. (In both tables, “SF” refers to “spreading factor.”)

TABLE 1
Random-access message data fields

| | Channel | | Channel | | | | |
|---|---|---|---|---|---|---|---|
| Slot | Bit Rate | | Symbol | | | | |
| Format#i | (kbps) | Modulation | Rate (ksps) | SF | Bits/Frame | Bits/Slot | Ndata |
| 0 | 15 | BPSK | 15 | 256 | 150 | 10 | 10 |
| 1 | 30 | BPSK | 30 | 128 | 300 | 20 | 20 |
| 2 | 60 | BPSK | 60 | 64 | 600 | 40 | 40 |
| 3 | 120 | BPSK | 120 | 32 | 1200 | 80 | 80 |
| 4 | 240 | QPSK | 120 | 32 | 2400 | 160 | 160 |
| 5 | 480 | QPSK | 240 | 16 | 4800 | 320 | 320 |

TABLE 2
Random-access message control fields

| | | | Channel | | | | | |
|---|---|---|---|---|---|---|---|---|
| | Channel | | Symbol | | | | | |
| Slot | Bit Rate | | Rate | | | | | |
| Format#i | (kbps) | Modulation | (ksps) | SF | Bits/Frame | Bits/Slot | Npilot | NTFCI |
| 0 | 15 | BPSK | 15 | 256 | 150 | 10 | 8 | 2 |
| 1 | 30 | BPSK | 30 | 128 | 300 | 20 | 12 | 8 |

The above presumes the use of convolutional coding. Higher payload sizes may be attained through use of Turbo codes.

When a plurality of such adaptive modulation and coding-based communication protocols are available, the controller 21 can be configured to select a particular protocol to best meet the needs of a given application or to best accommodate a given operational condition or circumstance. To illustrate, and referring now to FIG. 4, the controller can be configured to select 41 a given selectable protocol from amongst a plurality of candidate adaptive modulation and coding schemes and to then use 42 that selected scheme when transmitting a given message during the random access procedure.

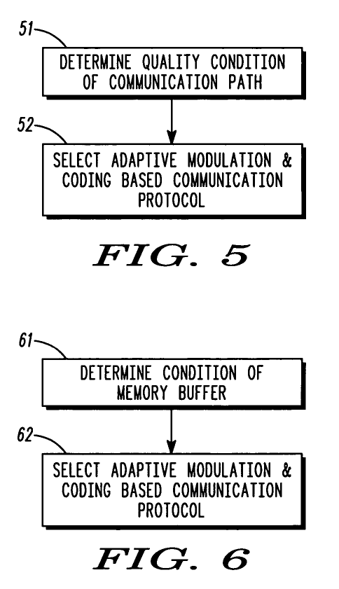

Such a selection can be based upon one or more criteria as may be relevant to a given application. For example, and referring now to FIG. 5, the controller can determine 51 a quality condition of the wireless communication path and base the selection of a given adaptive modulation and coding-based communication protocol, at least in part, upon this quality condition. Quality can be ascertained in a variety of ways. For example, the difference between transmit and receive power level of the common pilot channel (CPICH) can be used to ascertain uplink channel quality. The transmit power level of the CPICH can be conveniently broadcast on the FACH. As a simple illustration, when the communication path exhibits high quality, a higher throughput protocol can be selected. Conversely, when the communication path exhibits poorer quality the controller 21 can select a reduced throughput protocol.

As another example, and referring now to FIG. 6, a present or anticipated condition of the user equipment memory buffer can be ascertained 61 and a particular protocol selected 62 as a function, at least in part, of that condition. To illustrate, low or empty buffer occupancy conditions may bias the protocol selection towards a reduced throughput protocol. Similarly, higher buffer occupancy conditions may justify selection of a relatively higher throughput protocol.

Other criteria can of course be employed as appropriate to the needs, requirements, and sensitivities of a particular system, context, and application.

Automatic-Repeat-Request (ARQ) schemes are used in packet data communication system. The simplest form of hybrid ARQ scheme was proposed by Chase. The basic idea in Chase's scheme is to send a number of repeats of each coded data packet and allowing the decoder to combine multiple received copies of the coded packet weighted by the SNR prior to decoding. This method provides diversity gain and is very simple to implement. Turbo codes can also be used to improve the efficiency of hybrid ARQ schemes. Instead of sending simple repeats of the coded data packet, this form of hybrid ARQ sends progressive parity packets corresponding to code rate of R=¾, ½, ⅓ etc i.e. in each subsequent transmission of the packet the code rate is increased. This form of Hybrid ARQ scheme is called Incremental Redundancy (IR).

Referring again to FIG. 2, as noted earlier, the controller 21 also has access, in a preferred embodiment, to at least one HARQ-based communication protocol. So configured, the controller 21 can use an HARQ-based scheme to transmit a message using the communication resource during the random access portion of the CELL_FACH state of the communication resource. Various HARQ schemes are presently known (and others will likely be developed in the future) and should be considered as compatible with these teachings. To illustrate, the controller 21 could use an incremental redundancy HARQ-based communication protocol or a chase style HARQ-based communication protocol (with both such HARQ approaches being generally well understood in the art). In one embodiment only one HARQ protocol would be available for use by the controller 21. Pursuant to another approach, multiple HARQ protocols can be provided with a given protocol being selected to best suit present needs and/or present operating conditions.

Use of an HARQ protocol will typically entail the need to permit the transmission of acknowledgement messages. Such a need can be accommodated in a variety of ways. For example, the 3GPP Specification 25.211 can provide an acknowledgement field in downlink acquisition indicator channel used for sending acknowledgement of the preamble part of the RACH. This field can be utilized for HARQ acknowledgement messages if desired. In particular, 1,024 currently unused chips can be allocated to such an acknowledgement function (it would likely be preferred to transmit such an acknowledgement at a higher power than the acquisition indicator portion to improve reliability of the reception). As another example, such acknowledgements can also be sent on a separate acquisition indication channel (for example, a lower power channel (characterized by, for example, 4,096 chips) can be used to serve this purpose).

The uplink presently defined by the 3GPP standard noted above is considerably enhanced pursuant to these various embodiments. In particular, improving the performance of the CELL_FACH state enhances the peak rate of data transmission and significantly reduces the latency of the uplink. One can also expect to achieve higher sector and user packet call throughput. Notwithstanding these benefits, these embodiments can be realized with only minimal changes to the existing relevant standards.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method for use with a communication path comprising:
providing, from time to time, a plurality of dedicated channels for specified users to facilitate relatively high data transmission rate communications for the specified users;
providing, at least at some times other than when the plurality of dedicated channels are provided, random access communication opportunities, wherein the random access communication opportunities comprise at least one of:
an HARQ-based communication protocol; and
an adaptive modulation and coding-based communication protocol.

2. The method of claim 1 wherein the random access communication opportunities correspond to a message portion of a random access procedure.

3. The method of claim 1 wherein the random access communication opportunities comprises a modified slotted ALOHA protocol.

4. The method of claim 1 wherein the communication path comprises, at least in part, a wireless communication path.

5. The method of claim 1 wherein the random access communication opportunities further comprise use of a plurality of selectable message frames of differing sizes.

6. The method of claim 5 wherein the plurality of selectable message frames of differing sizes comprises at least a first selectable frame of about 3.33 milliseconds in duration, a second selectable frame of about 10.0 milliseconds in duration, and a third selectable frame of about 20.0 milliseconds in duration.

7. The method of claim 1 wherein the adaptive modulation and coding-based communication protocol further comprises use of a plurality of selectable modulation and coding protocols.

8. The method of claim 7 wherein the plurality of selectable modulation and coding protocols comprises at least:
a first selectable protocol comprising binary phase shift keying and various channel coding rates;
a second selectable protocol comprising quadrature phase shift keying and various channel coding rates; and
a third selectable protocol comprising 8 phase shift keying and various channel coding rates.

9. The method of claim 1 and further comprising selecting a particular adaptive modulation and coding-based communication protocol as a function, at least in part, of a quality condition of the communication path.

10. The method of claim 1 and further comprising selecting a particular adaptive modulation and coding-based communication protocol as a function, at least in part, of a condition of a memory buffer of a particular communication unit.

11. The method of claim 1 wherein the HARQ-based communication protocol further comprises an incremental redundancy HARQ-based communication protocol.

12. The method of claim 1 wherein the HARQ-based communication protocol further comprises a chase style HARQ-based communication protocol.

13. The method of claim 1 wherein at least one of the HARQ-based communication protocols comprises transmission of an acknowledgement message.

14. The method of claim 13 wherein the acknowledgement message is sent using an acquisition indicator channel (AICH) transmitted in a downlink direction.

15. The method of claim 1 wherein at least one of the HARQ-based communication protocols comprises transmission of an acknowledgement message using an acknowledgement field in a downlink acquisition indicator channel preamble message.

16. The method of claim 1 wherein the random access communication opportunities comprise both of:
an HARQ-based communication protocol; and
an adaptive modulation and coding-based communication protocol.

17. A method for utilizing a communication resource during a random access communication opportunity using a random access procedure to facilitate transmission of a message comprising bearer content, comprising:
selecting, from amongst a plurality of candidate adaptive modulation and coding schemes, a particular adaptive modulation and coding scheme;
using the particular adaptive modulation and coding scheme to transmit the message using the communication resource during the random access communication opportunity of the communication resource.

18. The method of claim 17 wherein the plurality of candidate adaptive modulation and coding schemes comprise at least:
a first selectable protocol comprising binary phase shift keying and various channel coding rates;
a second selectable protocol comprising quadrature phase shift keying and various channel coding rates; and
a third selectable protocol comprising 8 phase shift keying and various channel coding rates.

19. The method of claim 17 wherein selecting a particular adaptive modulation and coding scheme comprises selecting the particular adaptive modulation and coding scheme as a function, at least in part, of a quality condition of the communication resource.

20. The method of claim 17 wherein selecting a particular adaptive modulation and coding scheme comprises selecting the particular adaptive modulation and coding scheme as a function, at least in part, of a buffer condition of a particular communication unit.

21. The method of claim 17 and further comprising selecting, from amongst a plurality of candidate frame durations, a particular frame to use when transmitting the message using the communication resource during the random access communication opportunity.

22. The method of claim 21 wherein the plurality of candidate frame durations comprise at least a plurality of selectable frames of differing sizes comprises at least a first selectable frame of about 3.33 milliseconds in duration, a second selectable frame of about 10.0 milliseconds in duration, and a third selectable frame of about 20.0 milliseconds in duration.

23. The method of claim 17 and further comprising using an HARQ-based communication protocol scheme to transmit the message using the communication resource during the random access procedure.

24. A method for utilizing a communication resource during a random access portion of a CELL_FACH state to facilitate transmission of a message comprising bearer content, comprising:
determining availability of the communication resource during the CELL_FACH state;
using an HARQ-based scheme to transmit the message using the communication resource during the random access portion of the CELL-FACH state of the communication resource.

25. The method of claim 24 wherein the HARQ-based scheme further comprises an incremental redundancy HARQ-based communication protocol.

26. The method of claim 24 wherein the HARQ-based scheme further comprises a chase style HARQ-based communication protocol.

27. The method of claim 24 wherein the HARQ-based scheme comprises transmission of an acknowledgement message using an acquisition indicator channel (AICH) transmitted in the downlink direction.

28. The method of claim 24 wherein the HARQ-based scheme comprises transmission of an acknowledgement message using acknowledgement field in a downlink acquisition indicator channel.

29. The method of claim 27 and further comprising:
receiving the acquisition indicator channel;
determining a positive/negative state of an AICH channel bit;
determining whether to combine a received transmission with a previously received transmission prior to decoding the received transmission as a function, at least in part, of the positive/negative state of the AICH channel bit.
